(19) United States
(12) Patent Application Publication
(10) Pub. No.: US 2010/0152634 A1
(43) Pub. Date: Jun. 17, 2010

(54) Rotating Stream Oral Hygiene System

(76) Inventor: Norman Dove, North Vancouver (CA)

Correspondence Address: STEPHEN R. BURRI, MILLER THOMSON LLP, 1000 - 840 HOWE STREET, VANCOUVER, BC, V6Z 2M1, CA

(21) Appl. No.: 12/639,842

(22) Filed: Dec. 16, 2009

Related U.S. Application Data
(60) Provisional application No. 61/138,432, filed on Dec. 17, 2008.

(51) Int. Cl. A61C 17/02; A61H 13/00

(52) U.S. Cl. 601/162

(57) ABSTRACT

An oral hygiene system for cleaning teeth and gums with a fluid, the system comprising a reservoir for storing the fluid; a body portion connected to the reservoir, having pumping means a motor, for controllably drawing fluid from the reservoir; and a nozzle extending from the body portion for receiving the fluid from the reservoir and having a distal tip for discharging the fluid to a user's teeth and gums; wherein the fluid is discharged as a single rotating stream from the distal tip of the nozzle. There may be a valve for controlling the flow of fluid, which may be water, a dental rinse, or other desired fluid.

### FIELD OF THE INVENTION

The present invention relates to oral hygiene systems. In particular, the present invention relates to oral hygiene systems using a liquid jet discharge to clean teeth and gums.

### BACKGROUND OF THE INVENTION

It is known to provide oral hygiene devices which use one or more streams of water to facilitate teeth and gum cleaning. One example of such includes a jet nozzle provided with a nozzle head having a discharge port from which a single jet is dischargeable. The jet may be fanned out into multiple jets. The single or multiple jets may be directed against the teeth and gums to dislodge food particles and other debris.

There are problems with this type of oral hygiene device. A stream of water directed at teeth and gums, upon encountering debris thereon, may drive the debris between the teeth and gums. To minimize this result, it would be desirable to provide an oral hygiene device which discharges a rotating water stream to effect improved teeth and gum cleaning.

### BRIEF DESCRIPTION OF THE DRAWINGS

A detailed description of the preferred embodiments is provided by way of example only and with reference to the following drawings, in which:

FIG. 1 illustrates a schematic of a nozzle for an oral hygiene system having a hand-held body with a nozzle attached thereto, according to one embodiment of the present invention;

FIG. 2 illustrates a cross-sectional view through line 2-2 of FIG. 1;

FIG. 3 illustrates a cross-sectional view of a nozzle for an oral hygiene system, according to another embodiment of the invention, in which the nozzle includes a spiral channel running the length of the nozzle to create rifling; and

FIG. 4 illustrates a cross-sectional view of a nozzle for an oral hygiene system, according to yet another embodiment of the invention, in which the nozzle includes a spiral ridge running the length of the nozzle to create rifling.

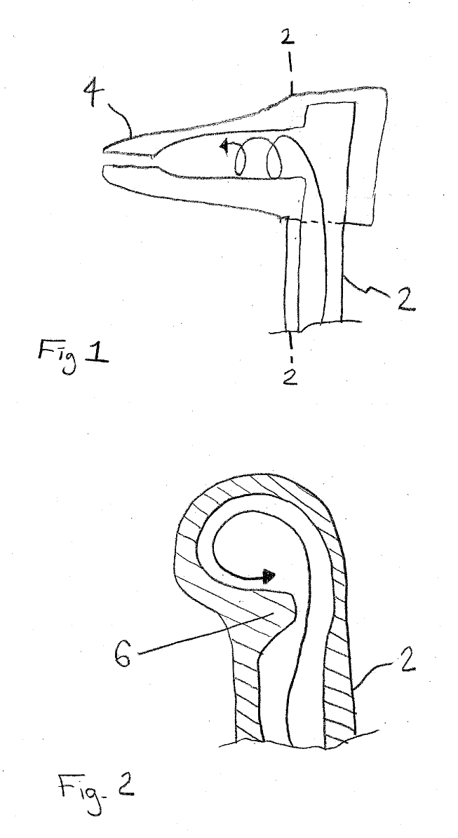

In the drawings, one embodiment of the invention is illustrated by way of example. It is to be expressly understood that the description and drawings are only for the purpose of illustration and as an aid to understanding, and are not intended as a definition of the limits of the invention.

### SUMMARY OF THE INVENTION

The present invention provides an oral hygiene system for cleaning teeth and gums with a fluid, the system comprising a reservoir for storing the fluid; a body portion connected to the reservoir, having pumping means a motor, for controllably drawing fluid from the reservoir; and a nozzle extending from the body portion for receiving the fluid from the reservoir and having a distal tip for discharging the fluid to a user's teeth and gums; wherein the fluid is discharged as a single rotating stream from the distal tip of the nozzle. In one embodiment, there may be a valve for controlling the flow of fluid. The fluid of the system of the invention may be water, a dental rinse, or other desired fluid.

The pumping means may comprise a pump, and a drive mechanism coupling the motor to the pump. Alternatively, the pumping means may comprise a container of compressed air having a valve for controllable release of the compressed air.

The nozzle or a tube feeding the nozzle may have a single continuous spiral ridge or a plurality of parallel continuous spiral ridges extending along the longitudinal axis of the nozzle to effect rotation of the fluid stream. Alternatively, the nozzle or a tube feeding the nozzle may have a single spiral channel or a plurality of parallel continuous spiral channels extending along the longitudinal axis of the nozzle to effect rotation of the fluid stream.

In another embodiment, the fluid may be received in the nozzle from the body at an angle tangential to the longitudinal axis of the nozzle to effect rotation of the fluid stream. The tangential angle of entry may be achieved by inclusion of a diversion element within the nozzle to redirect the flow of fluid.

### DESCRIPTION OF THE INVENTION

According to one embodiment of the present invention, there is provided an oral hygiene system of the type having a fluid reservoir, a hand-held wand 2 and a nozzle 4 extending from the wand, and pumping means for directing the fluid from the reservoir, through the wand, and through the nozzle to be discharged from the distal tip of the nozzle. The device may include a valve for controlling the flow of fluid through the nozzle. The pumping means may comprise an electric motor and air pump. Alternatively, the pumping means may comprise a container of compressed air.

In the present invention, the initially laminar stream of fluid is converted into a rotating stream of fluid, a vortex. Whereas the laminar stream will tend to drive debris in the oral cavity in the direction of the stream flow directly into the teeth and gums, a rotating stream will tend to drive debris in the direction of the rotation, perpendicular to the direction of stream flow. The resultant effect is a sweeping motion which provides improved debris removal and reduces collection of debris between teeth and gums during operation.

The rotation of the fluid stream may be generated in a variety of ways. In a preferred embodiment, the desired vortex may be achieved by introducing the fluid from the wand into the nozzle in a direction tangential to the longitudinal axis of the nozzle. The flow of fluid may be redirected into a tangential flow with a diversion element 6 within the nozzle, as depicted in FIG. 2.

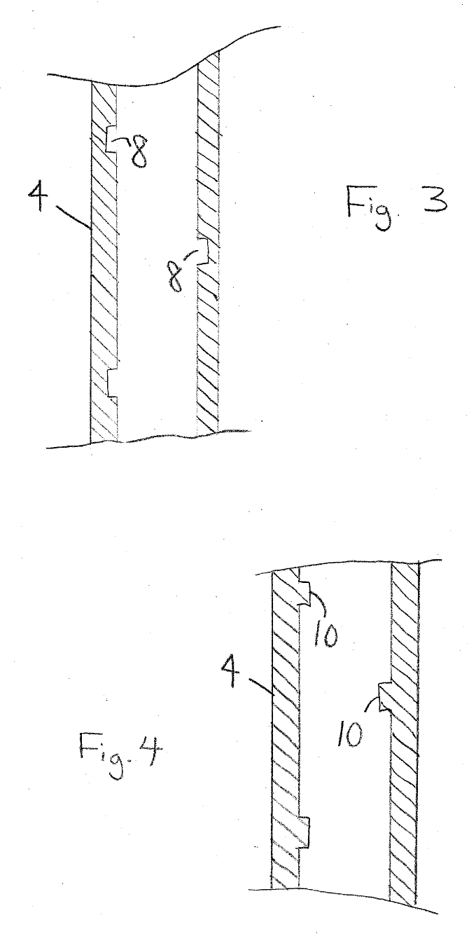

In an alternate embodiment, the inside of the nozzle or of the tube feeding the nozzle may include a single spiral channel 8 as depicted in FIG. 3 or a plurality of parallel spiral ridges extending from one end of the nozzle or tube feeding the nozzle to the other end. The laminar stream is thereby channeled into a vortex prior to exiting the distal tip of the nozzle.

In yet another alternate embodiment, the inside of the nozzle or of the tube feeding the nozzle may include a single spiral ridge 10 as depicted in FIG. 4 or a plurality of parallel spiral channels extending from one end of the nozzle or tube feeding the nozzle to the other end. As with the spiral ridge embodiment, the laminar stream is channeled into a vortex prior to exiting the distal tip of the nozzle.

In one embodiment of the present invention, the nozzle may be selectively removable. A plurality of nozzles may be provided to permit use of the system by multiple users, each using a different nozzle or nozzles.

In a preferred embodiment of the system of the invention, the fluid is water. The fluid may also be a mouthwash or other dental rinse having antiseptic, tooth whitening, or other desirable properties.

The embodiment of system of the present invention which uses a container of compressed air as pumping means may be portable and may be used while traveling, camping, during power outages or at other times when portability is desirable.

Further features, advantages and application possibilities of the present invention will become apparent from the subsequent description of embodiments illustrated in more detail in the accompanying drawings.

It will be appreciated by those skilled in the art that other variations of the preferred embodiment may also be practiced without departing from the scope of the invention.

What is claimed is:

1. An oral hygiene system for cleaning teeth and gums with a fluid, the system comprising:
a reservoir for storing the fluid;
a body portion connected to the reservoir, having pumping means for controllably drawing fluid from the reservoir; and
a nozzle extending from the body portion for receiving the fluid from the reservoir and having a distal tip for discharging the fluid to a user's teeth and gums;
wherein the fluid is discharged as a single rotating stream from the distal tip of the nozzle.

2. The oral hygiene system of claim 1, further comprising a valve for controlling the flow of fluid through the nozzle.

3. The oral hygiene system of claim 1, wherein the nozzle further comprises a continuous spiral ridge extending along the longitudinal axis of the nozzle to effect rotation of the fluid stream.

4. The oral hygiene system of claim 1, wherein the nozzle further comprises a plurality of parallel continuous spiral ridges extending along the longitudinal axis of the nozzle to effect rotation of the fluid stream.

5. The oral hygiene system of claim 1, wherein the nozzle further comprises a continuous spiral channel extending along the longitudinal axis of the nozzle to effect rotation of the fluid stream.

6. The oral hygiene system of claim 1, wherein the nozzle further comprises a plurality of parallel continuous spiral channels extending along the longitudinal axis of the nozzle to effect rotation of the fluid stream.

7. The oral hygiene system of claim 1, wherein the fluid enters the nozzle at an angle tangential to the longitudinal axis of the nozzle to effect rotation of the fluid stream.

8. The oral hygiene system of claim 7, wherein the body further comprises a diverter element for redirecting the fluid to a tangential angle.

9. The oral hygiene system of claim 7, wherein the nozzle further comprises a diverter element for redirecting the fluid to a tangential angle.

10. The oral hygiene system of claim 1 wherein the fluid is water.

11. The oral hygiene system of claim 1, wherein the fluid is a dental rinse.

12. The oral hygiene system of claim 1, wherein the pumping means comprises a motor, a pump, and a drive mechanism coupling the motor to the pump.

13. The oral hygiene system of claim 1, wherein the pumping means comprises a compressed air container having a valve for controllable release of the compressed air.
